(19) United States
(12) Patent Application Publication
(10) Pub. No.: US 2014/0372134 A1
(43) Pub. Date: Dec. 18, 2014

(54) Online Health Care Marketplace

(71) Applicant: OneDoc, Inc., Oklahoma City, OK (US)

(72) Inventor: Sami S. Dahr, Oklahoma City, OK (US)

(73) Assignee: OneDoc, Inc., Oklahoma City, OK (US)

(21) Appl. No.: 14/288,619

(22) Filed: May 28, 2014

Related U.S. Application Data
(60) Provisional application No. 61/836,125, filed on Jun. 17, 2013.

(51) Int. Cl. G06Q 50/22; G06Q 10/10

(52) U.S. Cl. CPC G06Q 50/22; G06Q 10/10
USPC 705/2

(57) ABSTRACT

A health care marketplace is established that defines a set of medical service packages. Each medical service package includes information about one or more medical services, as well as pricing information about the medical services. Providers that offer one or more of the medical service packages are also established within the health care marketplace. The consumer inputs medical or personal information, which is used to recommend one or more of the medical service packages and providers to the consumer. Finally, a purchase of one of the recommended medical service packages from one of the recommended providers is facilitated.

### CROSS REFERENCE TO RELATED APPLICATIONS

This application claims the benefit of U.S. Provisional Application No. 61/836,125 filed Jun. 17, 2013, which is hereby incorporated by reference herein.

### BACKGROUND

In recent years, individuals have increasingly become responsible for self-contracting at least a portion of their own medical care. In the United States, employer-financed health care is declining, and government-sponsored health care could decline in the future as well. Therefore, more consumers are finding and paying for medical services on their own. Consumers find this process complicated for several reasons: comparison shopping for health care is difficult and time consuming, pricing structures may lack transparency and lead to “surprise” charges on medical bills, and consumers may not always be informed of the medical services they need.

On the other hand, health care providers could benefit from contracting directly with consumers. By working with consumers instead of insurance companies, providers may receive upfront payments and have lower overhead expenses. However, the current perception among providers is that many self-contracting consumers will take up time and resources by asking questions, negotiating prices, and failing to commit or show up to appointments.

### SUMMARY

Disclosed herein are methods for providing a health care marketplace. In one embodiment, one method includes defining medical service packages offered in the health care marketplace, each medical service package including information about medical services included in the medical service package. Providers are established within the health care marketplace, each provider offering one or more of the medical service packages at specified prices. Information associated with a consumer is then received, and based on this received information, descriptions of one or more of the medical service packages and a list of one or more providers offering the one or more medical service packages are presented to the consumer. Finally, a purchase is facilitated on behalf of the consumer of a presented medical service package at a specified price from one of the providers in the list.

In one embodiment, personal medical information about the consumer is established based at least in part on the received information associated with the consumer, and one or more of the medical service packages is recommended for the consumer based on the received personal medical information. In a further embodiment, the personal medical information about the consumer includes demographic data about the consumer, past health condition data about the consumer, family history data about the consumer, and/or social history data about the consumer.

In another embodiment, a user interface is provided to the providers, and the user interface lists at least a subset of the defined medical service packages. Selection information is then received from the provider, which indicates one or more of the listed medical service packages offered by the provider. In a separate embodiment, targeting criteria is received from a provider, and the targeting criteria describes consumers to whom the provider is offering an associated medical packages, such that the list of providers that offer the medical service packages is presented to the consumer based on the information associated with the consumer and the targeting criteria received from the provider. In another embodiment, facilitating the purchase of the presented medical service package includes facilitating a solicitation for a payment for a package by an individual other than the consumer.

In some embodiments, scheduling information is received from a provider, the scheduling information indicating when the provider is available to perform the presented medical service package. Performance of the presented medical service package is scheduled responsive to this scheduling information. In other embodiments, a questionnaire is provided to the consumer, the questionnaire prompting answers from the consumer describing the consumer's personal medical history. Answers are received to the questionnaire from the consumer, and one or more medical service packages are recommended for the consumer based on the received answers, such that the presenting of descriptions of the medical service packages includes presenting descriptions of the recommended medical service packages to the consumer.

In an embodiment, one or more geographic locations of provider facilities offering the medical service packages is established, and a selection of one of the geographic locations of provider facilities is received from the consumer. Then, the purchase of one of the recommended medical service packages is facilitated such that the purchased medical service package is associated with the selected geographic location of a provider facility.

Also disclosed herein are non-transitory computer-readable storage mediums storing instructions for providing a health care marketplace. In an embodiment, the instructions when executed by a processor cause the processor to: define medical service packages offered in the health care marketplace, each medical service package including information about medical services included in the medical service package. Providers are established within the health care marketplace, each provider offering one or more of the medical service packages at specified prices. Information associated with a consumer is then received, and based on this received information, descriptions of one or more of the medical service packages and a list of one or more providers offering the one or more medical service packages are presented to the consumer. Finally, a purchase is facilitated on behalf of the consumer of a presented medical service package at a specified price from one of the providers in the list.

In an embodiment, the processor also establishes personal medical information about the consumer based on the received information associated with the consumer, and recommends one or more medical service packages for the consumer based on the received personal medical information. In a further embodiment, the personal medical information about the consumer includes demographic data about the consumer, past health condition data about the consumer, family history data about the consumer, and/or social history data about the consumer.

In one embodiment, the processor further provides a user interface to a provider, which lists a subset of the defined medical service packages, and the processor receives selection information from the provider, which indicates one or more of the listed medical service packages offered by the provider. In another embodiment, the processor receives targeting criteria from a provider, and the targeting criteria describes consumers to whom the provider offers an associated medical service packages. The list of providers offering the described medical service packages is presented to the consumer based on the information associated with the consumer and the targeting criteria received from the provider. In another embodiment, facilitating the purchase of the presented medical service package includes facilitating a solicitation for a payment for a package by an individual other than the consumer.

In an embodiment, the processor receives scheduling information from a provider, the scheduling information indicating when the provider is available to perform the presented medical service package. The processor also schedules performance of the presented medical service package responsive to the scheduling information. In another embodiment, the processor provides a questionnaire to the consumer, the questionnaire prompting answers from the consumer describing the consumer's personal medical history. The processor also receives the answers to the questionnaire from the consumer, and recommends one or more medical service packages for the consumer based on the received answers, such that the presenting of descriptions of the medical service packages includes presenting descriptions of the recommended one or more of the medical service packages to the consumer.

Also disclosed herein are computer systems, which include a processor, as well as a memory storing instructions executable by the processor to define medical service packages offered in a health care marketplace, each medical service package including information about medical services included in the medical service package. Providers are established within the health care marketplace, each provider offering one or more of the medical service packages at specified prices. Information associated with a consumer is then received, and based on this received information, descriptions of one or more of the medical service packages and a list of one or more providers offering the one or more medical service packages are presented to the consumer. Finally, a purchase is facilitated on behalf of the consumer of a presented medical service package at a specified price from one of the providers in the list.

In an embodiment, the memory is further executable by the processor to establish personal medical information about the consumer based on the received information associated with the consumer, and to recommend one or more medical service packages for the consumer based on the received personal medical information. In another embodiment, facilitating the purchase of the presented medical service package includes facilitating a solicitation for a payment for a package by an individual other than the consumer.

### BRIEF DESCRIPTION OF THE DRAWINGS

FIG. 1 is a high-level block diagram illustrating an environment including a health care marketplace, in accordance with an embodiment of the invention.

FIG. 2 is a high-level block diagram illustrating a detailed view of various modules within the health care marketplace, in accordance with an embodiment of the invention.

FIG. 3 is a flowchart illustrating steps performed by the health care marketplace to facilitate the consumer purchase of a medical service package, in accordance with an embodiment of the invention.

FIG. 4 is a high-level block diagram illustrating an example of a computing device for acting as one or more of the entities illustrated in FIG. 1, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

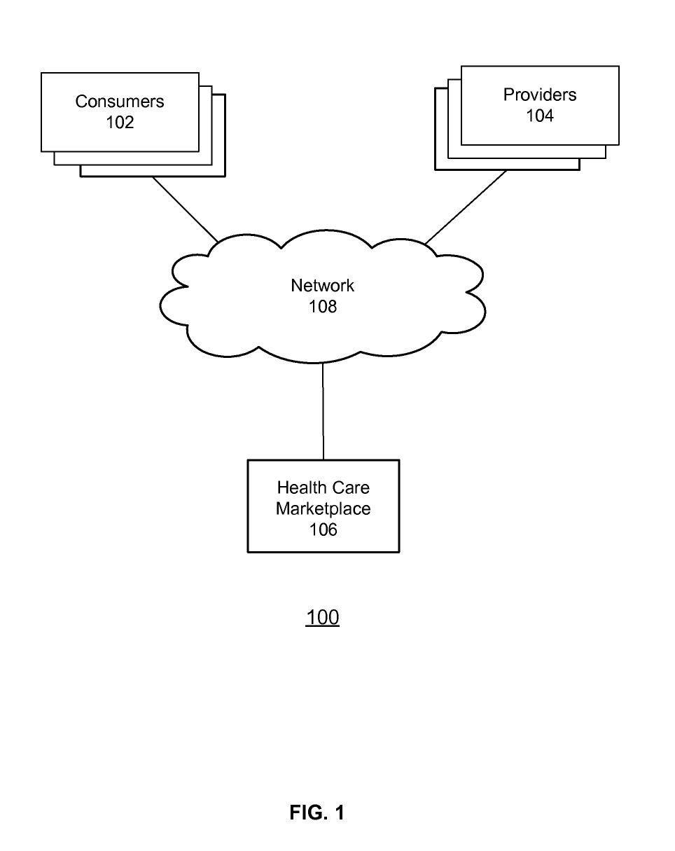

FIG. 1 is a high-level block diagram illustrating an environment 100 including a health care marketplace 106 according to one embodiment. A network 108 connects the health care marketplace 106 to multiple consumers 102 and multiple providers 104. Only three examples are shown for each of the consumers 102 and providers 104 (represented by the stacked rectangles). However, there can be thousands or millions of each entity in some embodiments. Moreover, the environment 100 may also include multiple networks 108 and health care marketplaces 106.

The consumers 102 are entities that use computing devices to interact with the health care marketplace 106 in order to research, purchase, and schedule medical services. A consumer 102 is generally an individual (or an agent of the individual) who wishes to contract for a medical service package. The consumer 102 may provide personal information to the health care marketplace 106 and receive customized recommendations for medical service packages in response. In addition, the consumer may receive pricing information for the packages and descriptions of providers 104 that will provide the medical service packages for the specified prices.

The providers 104 are also entities that use computing devices to interact with the health care marketplace 106. A provider 104 provides medical services. A provider 104 may be a hospital, a hospital system, a primary care center, a clinic, or any other entity that provides medical services. Using the health care marketplace 104, a provider 104 selects and/or specifies medical service packages that it provides. In addition, the provider 104 specifies pricing information for the medical service packages. The provider 104 also provides additional information that may be used by consumers 102 when considering obtaining medical services from the provider, such as scheduling information indicating when the provider can provide the services, location information describing the geographic location of the provider, and marketing information describing the provider.

The health care marketplace 106 facilitates interactions enabling the consumers 102 to purchase medical service packages from providers 104. In one embodiment, the health care marketplace 106 is implemented using one or more computing devices to form a web site accessible to the consumers 102 and providers 104 via the network 108. The health care marketplace 106 may also be implemented as an application that executes on the computing devices of the consumers 102 and providers 104 and communicates with the marketplace via the network 108.

The health care marketplace 106 defines a set of medical service packages including a specified set of components. The providers 104 establish accounts with the health care marketplace 106, provide information about the providers and the medical service packages offered by the providers, and pricing for the packages. Likewise, the consumers 102 may establish accounts with the health care marketplace 106, provide information about the consumers, and use the marketplace to review and select medical service packages from the providers 104. In some embodiments, consumers 102 and providers 104 can interface with the health care marketplace 106 through a state or federal government-based insurance exchange. The health care marketplace 106 may also perform additional functions, such as recommending medical service packages to consumers 102, scheduling consumers' visits to providers 104, billing consumers and paying providers, and enabling communications and other social activities between the consumers and providers.

The network 108 facilitates communications between the health care marketplace 106, the providers 104, the consumers 102, and other parties. In an embodiment, the network 108 uses standard communications technologies and/or protocols. In some embodiments, the health care marketplace 106, providers 104, and consumers 102 can use custom and/or dedicated data communications technologies.

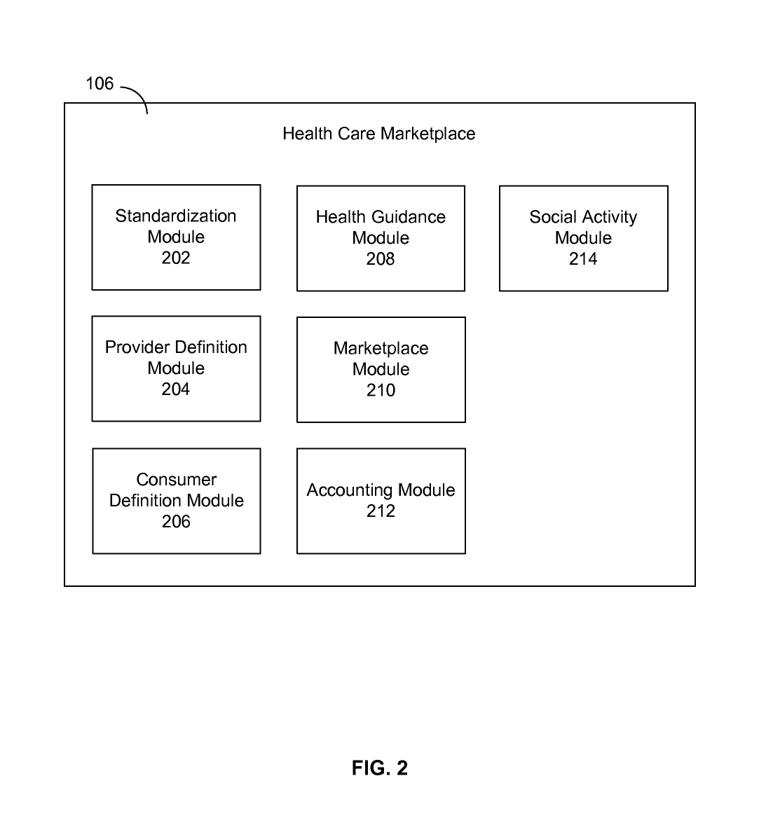

FIG. 2 is a high-level block diagram illustrating a detailed view of various modules within the health care marketplace 106, in accordance with an embodiment of the invention. As used herein, the term “module” refers to computer program logic used to provide a specified functionality. As illustrated, the health care marketplace 106 includes a standardization module 202, a provider definition module 204, a consumer definition module 206, a health guidance module 208, a marketplace module 210, an accounting module 212, and a social activity module 214. Some embodiments of the health care marketplace 106 have different and/or other modules than the ones described herein. Similarly, the functions can be distributed among the modules in accordance with other embodiments in a different manner than is described here.

The standardization module 202 defines standard medical service packages. A medical service package is a set of one or more medical procedures, charges, or other components that are bundled together into a single, standardized unit. A medical service package may include a set of components that are associated with a single visit. For example, a medical service package for an annual eye exam by an ophthalmologist might include a medical history review, visual acuity test, peripheral vision test, dilation, and glasses refraction. Similarly, a gynecologic exam may be standardized to include a pap smear among other components. For surgical or procedural services involving inpatient or outpatient care that occur in outpatient ambulatory surgery centers (ASCs), procedural suites (e.g., colonoscopy), or hospitals, the medical service package may include the service itself, the materials used to provide the service, and the fees associated with the service, such as the facility fee, the anesthesia services fee, the surgeon/proceduralist fee, and post procedural care for a specified period of time.

In one embodiment, the standardization module 202 defines many such medical service packages. Common services that may be standardized into medical service packages include: yearly history and physical evaluation, comprehensive eye exam, hearing test and hearing aid, allergy testing, dermatologic skin survey, heart stress test, EKG, basic blood count/chemistry/cholesterol, well baby checkup, diabetes and blood pressure checkup, gynecologic exam, urgent care evaluation, chest x-ray, dietary counseling, wellness programs, mental health services, cataract surgery, retinal detachment surgery, LASIK, cosmetic procedures/medical spa, dental cleaning, wisdom tooth extraction, dental crown, mole removal, vasectomy, gynecologic procedures, colonoscopy screening, vaccination, mammography, pain management injection, and laboratory tests.

In one embodiment, the standardization module 202 defines a medical service package that functions as an option to purchase a subsequent package at a discounted price, even though the consumer 102 does not currently require the associated service. The purchased option stays in effect for a particular period of time. For example, a medical service package may function as an option to purchase a discounted package covering an emergency room visit within a year. If the consumer 102 visits the emergency room within that time frame, the consumer 102 has the option of purchasing the discounted emergency room package for the visit.

The types of packages and components of the packages may be specified by human experts. For example, a human expert in a particular field of medicine may define medical service packages for common visits or procedures in that field Likewise, the experts may specify the components of each package based on medical guidelines, best practices, and/or other criteria. The standardization module 202 may store descriptions of each package, including the packages' components, in a database or other data store.

The provider definition module 204 interacts with and maintains data for the providers 104. In one embodiment, the provider definition module 204 allows providers 104 to activate accounts at the health care marketplace 106. As part of the account activation process, the provider definition module 204 receives information from a provider 104 describing the business operated by the provider and medical professionals associated with the provider, such as a mission statement regarding the provider's philosophy of care, photographs of the provider's facilities or employees, videos, employee credentials, articles, blog posts, and provider reviews. A provider 104 may provide this information by filling out a template offered by the provider definition module 204. The provider 104 also indicates the geographic location of an office maintained by the provider. In some embodiments, a particular medical professional is available to perform services at multiple provider facilities in different geographic locations. The provider definition module 204 may require the provider to agree to one or more legal contracts to provide services according to terms specified by the health care marketplace 106.

The provider definition module 204 allows a provider to offer one or more of the medical service packages defined by the standardization module 202. For example, the provider definition module 204 may provide a user interface that lists the medical service packages and the components of the package, and allows the provider to select individual packages in the list to offer. In one embodiment, a provider 204 may offer additional components for a specific medical services package, in addition to the components already included in the package.

The provider definition module 204 also allows the providers to specify pricing for the offered medical service packages. The price for an offered medical service package is the amount the provider 104 agrees to charge to provide all of the components of the package, plus any additional components offered by the provider. The provider 104 may determine and adjust prices for medical service packages in real time. In some cases, the pricing information can vary for a particular medical service package based on a specific medical professional associated with the package or based on a specific provider facility associated with the package.

An embodiment of the provider definition module 204 further allows providers 104 to specify targeting criteria of consumers to whom the provider is offering services. For example, the provider definition module 204 may allow a provider 104 to specify demographic, financial/payment, and/or insurance information of consumers to whom the provider is offering a given package. The providers 104 may specify different targeting criteria associated with different medical service packages.

In one embodiment, the provider definition module 204 gives the providers pricing data that the providers can use to determine their pricing. The pricing data may include real-time data that depicts purchasing trends by consumers 102 and prices for standardized packages offered by other providers 104 using the health care marketplace. A provider 104 can adjust package prices accordingly after viewing this data.

An embodiment of the provider definition module 204 also performs scheduling on behalf of the providers 104. To this end, the provider definition module 204 collects scheduling information indicating dates and times when the providers 104 are available to perform the offered medical service packages. The provider definition module 204 also schedules the providers 204 to perform one or more components of packages purchased by consumers 102.

The consumer definition module 206 interacts with and maintains data for the consumers 102. In one embodiment, the consumer definition module 206 allows consumers 102 to activate accounts at the health care marketplace 106. As part of the account activation process, an embodiment of the consumer definition module 201 receives information from a consumer 102, such as the consumer's name, address, and billing/payment information. The payment information may include, e.g., a credit card number, debit account, bank account and routing number, or gift certificate. In an embodiment, a consumer 102 initiates a campaign to solicit gift card contributions or other donations from friends and family towards the consumer's 102 desired medical service package. The consumer can set and adjust the goal amount for the campaign, and the consumer definition module 206 can send periodic updates and messages to the friends and family.

Further, the consumer definition module 206 may collect personal medical information from the consumer 102. For example, the module 206 may collect a consumer's demographic data such as age, sex, ethnicity, height, and weight. A consumer definition module 206 may also collect information about a consumer's past health conditions, family history, and social history. In one embodiment, the consumer definition module 206 generates a customized questionnaire based on a consumer's 102 entered demographic data, and provides the questionnaire to the consumer 102 to prompt answers regarding the consumer's 102 past medical conditions, family history, and social history. The consumer definition module 206 may encrypt or otherwise secure the data received from the consumer 102. Based on the consumer's answers, one or more medical service packages can be recommended to the consumer.

The health guidance module 208 provides medical recommendations to consumers 102 based on the information provided by the consumers. In one embodiment, the health guidance module 208 includes a medical database containing information correlating consumer medical information with recommended medical procedures. The database may include information following established medical guidelines. For example, the database may contain health screening and medical service information from sources including medical literature, medical specialty societies, and government agencies such as the National Institutes of Health and Centers for Disease Control and Prevention. The database is continuously updated as new advances and discoveries in medicine are achieved.

The health guidance module 208 analyzes a consumer's 102 demographic and medical information using the database, and generates customized medical recommendations for the consumers 102. For example, the health guidance module 208 may recommend whether and how often certain medical procedures should be performed, such as: eye exams, prostate exams, gynecologic exams, pap smears, colonoscopies, cholesterol screenings, adult vaccinations, etc.

Further, an embodiment of the health guidance module 208 presents a consumer 102 with a graphical representation of a human body. The consumer 102 may then interact with the representation to identify the consumer's health concerns. For example, if the consumer is having knee pain, the consumer can interact with the representation of the body to identify the knee as the place of concern, and then use further tools provided by the health guidance module 208 to describe the location of the knee pain and/or other medical issues. The health guidance module 208 analyzes the consumer's 102 interactions with the representation of the body to generate a customized medical recommendation for the consumer.

The marketplace module 210 allows consumers 102 to view, select, and purchase medical service packages offered by the providers 104. In one embodiment, the marketplace module 210 initially establishes a set of medical service packages in which the consumer is potentially interested. The marketplace module 210 may interact with the health guidance module 208 to identify a set of one or more medical service packages that are appropriate for the consumer 102. For example, the marketplace module 210 may identify a set of medical service packages that meet the customized medical recommendation for the consumer 102. Likewise, the marketplace module 210 may identify a medical service package that is appropriate for the medical issue described by the consumer using the graphical representation of the human body. Additionally, the consumer 102 may interact with the marketplace module 210 to search directly for specific medical service packages. For example, the consumer may search by keyword, provider, medical condition, or other criteria.

Once the set of medical service packages is identified, the marketplace module 210 interacts with the provider definition module 204 to obtain a list of providers 204 offering the packages. The marketplace module 210 provides a description of a package and the providers 204 that offer the package to the consumer 202. The description of the package may list all of the components of the package. The description of a provider 104 that offers the package may include the price set by the provider for the package and at least some of the marketing information describing the provider. In some embodiments, the consumer 102 can select one or more components of a package, or select components from multiple packages, to create a customized medical service package based on the consumer's 102 specific medical or financial needs. In a further embodiment, a provider 104 can accept or deny the consumer's 102 customized medical service package, or the provider 104 can propose new prices for one or more components of the package. In another embodiment the consumer 102 selects these customizable components from a generic package with standardized pricing information accepted by most or all providers 104.

The marketplace module 210 may filter the medical service packages and/or list of providers using a variety of filtering criteria. These criteria may be specified by the consumer 102 and/or providers 104. The marketplace module 210 may filter the list of providers based upon the targeting criteria specified by the providers 104, so that a provider's package is offered to only consumers targeted by the provider. The marketplace module 210 may display only providers 104 that are geographically proximate to the consumer 102.

The marketplace module 210 may also allow the consumer 102 to filter the list of providers 104 by price, geographic location of a provider facility, availability, additional package components offered by the provider, social elements (such as consumer reviews of providers) and/or other criteria. For example, a consumer 102 may filter the list of providers 104 to show only providers within 20 miles of the consumer's 102 residence, and/or providers charging a maximum cost of $1000 for a particular package. A consumer 102 may also filter the list of providers 104 based on specific medical professionals available to perform medical services at the provider facilities. In one example, a particular medical professional may offer services at both facility A and facility B. The price of the medical service package can vary between the two facilities. If the consumer 102 filtered the list based on that medical professional, the consumer 102 can review the different prices and select an appropriate facility accordingly.

The consumer 102 may review the (filtered or unfiltered) list of providers and purchase a medical service package from a specific provider. In one embodiment, the marketplace module 210 interacts with the consumer 102 and provider 104 to schedule the consumer's appointment with the provider for the package. In a further embodiment, the marketplace module 210 allows the consumer to select and purchase drugs or other pharmaceuticals, durable medical goods, and medical devices associated with the purchased package or independent of the purchased package.

The accounting module 212 performs purchase transactions on behalf of consumers 102 and providers 104. In one embodiment, the accounting module 212 uses a consumer's specified payment information to pay for the selected package (e.g., by charging the consumer's credit card). The accounting module 212 also credits the provider 204 for the purchase.

The accounting module 212 also facilitates any special payment plans between a consumer 102 and a provider 104. For example, a low-interest financing option or deferred payment plan may be offered for consumers 102. In another embodiment, a provider 104 may require that extra fees be paid if a consumer 102 cancels or does not show up to an appointment.

The social activity module 214 facilitates social interactions between consumers 102 and providers 104 on the health care marketplace 106. The social activity module 214 allows consumers 102 and providers 104 to communicate with each other through messages or online chats. Furthermore, the social activity module 214 allows a consumer 102 to write a review and submit a rating regarding a particular provider 104. In one embodiment, the social activity module 214 provides a survey for the consumer 102 to fill out after a scheduled appointment, the survey prompting answers regarding the experience with the provider 104, the provider's 104 friendliness, professionalism, facilities, etc.

A provider 104 may also write a review and submit a rating regarding a particular consumer 102. In an embodiment, the social activity module 214 provides a survey for the provider 104 to fill out after a scheduled appointment, the survey prompting answers regarding whether a consumer 102 was prompt to a scheduled appointment and made timely payments, whether the consumer 102 complied with medical recommendations from the health care marketplace 106 or the provider 104, or whether the consumer 102 was friendly and agreeable. Completed reviews and ratings for a particular consumer 102 or provider 104 may be made available to other consumers 102 and providers 104 using the health care marketplace 106. These reviews and ratings could influence consumers 102 and providers 104 in deciding whether to offer or select medical service packages.

Further, an embodiment of the social activity module 214 aggregates relevant medical news to periodically provide a customized newsletter for a consumer 102. For example, a consumer 102 with diabetes may receive a newsletter containing any recent news regarding diabetes research or diabetes treatments. Furthermore, a consumer 102 may flag one or more medical topics of interest so that news and editorial content are made available to the consumer 102.

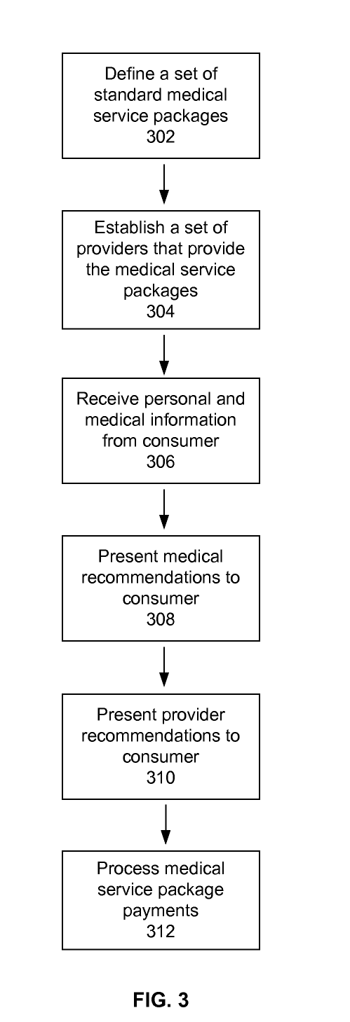

FIG. 3 is a flowchart illustrating steps performed by the health care marketplace 106 to facilitate the consumer purchase of a medical service package, according to one embodiment of the invention. Other embodiments of the health care marketplace 106 may perform different or additional steps, and may perform the steps in different orders.

Initially, a set of standard medical service packages are defined 302. A package is a set of one or more components that are bundled together into a single unit, so that each medical service package includes information about one or more medical services, and may include pricing information regarding the one or more medical services. In addition, a set of providers that offer the medical service packages is established 304. Each provider may additionally specify a price for providing the services and other components in a package.

The health care marketplace 106 receives information associated with a consumer, including personal and medical information 306. This information may include a search keyword, a provider, or demographic data, such as the consumer's 102 age, sex, ethnicity, height, and weight. The information may also include personal and family medical history, as well as social history. Based on this information, customized medical recommendations are generated and presented 308 to the consumer 102. The recommendations include descriptions of one or more of the medical service packages.

The health care marketplace 106 also presents 310 a list of providers 104 that offer the recommended medical service packages. This list may be filtered by geographic location, cost, appointment availability, or other factors. Once a consumer 102 selects a package from a particular provider 104, the consumer 102 may make an appointment and pay 312 for the service using a payment instrument. The consumer 102 and provider 104 may also contract for special payment plans, if any.

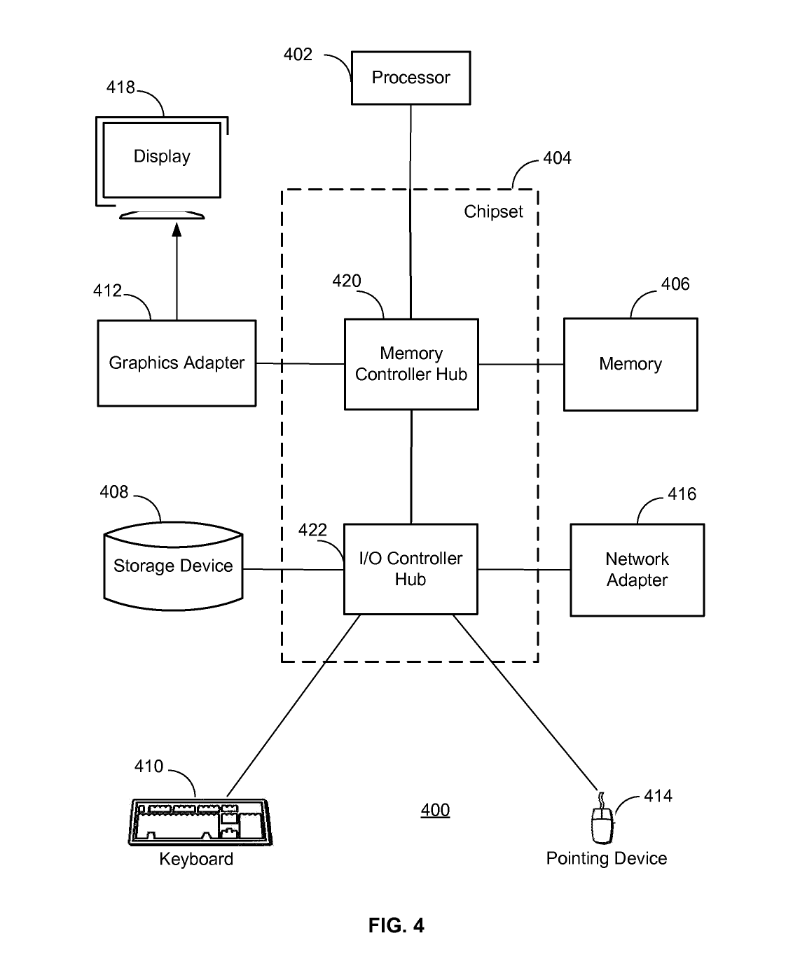

FIG. 4 is a high-level block diagram illustrating an example of a computing device for acting as one or more of the entities illustrated in FIG. 1, according to one embodiment. The computer 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, keyboard 410, pointing device 414, and network adapter 416 are coupled to the I/O controller hub 422. Other embodiments of the computer 400 have different architectures.

The storage device 408 is a non-transitory computer-readable storage medium such as a hard drive, compact disk read-only memory (CD-ROM), DVD, or a solid-state memory device. The memory 406 holds instructions and data used by the processor 402. The pointing device 414 is a mouse, touch screen, or other type of pointing device, and is used in combination with the keyboard 410 to input data into the computer system 400. The graphics adapter 412 displays images and other information on the display 418. The network adapter 416 couples the computer system 400 to one or more computer networks.

The computer 400 is adapted to execute computer program modules for providing functionality described herein. Since “module” refers to computer program logic used to provide the specified functionality, a module can be implemented in hardware, firmware, and/or software. In one embodiment, program modules are stored on the storage device 408, loaded into the memory 406, and executed by the processor 402.

The types of computer 400 used in the environment 100 of FIG. 1 can vary depending upon the embodiment and the processing power required for the uses. The computer 400 can lack some of the components described above, such as keyboards 410, graphics adapters 412, and displays 418. As an example, a consumer 102 or a provider 104 may use a computing device comprising a mobile telephone with a touch screen but no physical keyboard. The health care marketplace 106, in contrast, may use multiple server computers in a cloud-based environment.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A computer-implemented method for providing a health care marketplace, the method comprising:
defining a plurality of medical service packages offered in the health care marketplace, each medical service package comprising information about one or more medical services included in the medical service package;
establishing a plurality of providers within the health care marketplace, each provider offering one or more of the plurality of medical service packages at specified prices;
receiving information associated with a consumer;
presenting, by a computer processor, descriptions of one or more of the plurality of medical service packages and a list of one or more of the plurality of providers that offer the described one or more medical service packages to the consumer, based on the received information; and
facilitating a purchase on behalf of the consumer of a presented medical service package at a specified price from one of the providers in the list.

2. The computer-implemented method of claim 1, the method further comprising:
establishing personal medical information about the consumer based at least in part on the received information associated with the consumer; and
recommending one or more of the plurality of medical service packages for the consumer based on the received personal medical information.

3. The computer-implemented method of claim 2, wherein the personal medical information about the consumer comprise at least one of: demographic data about the consumer, past health condition data about the consumer, family history data about the consumer, and social history data about the consumer.

4. The computer-implemented method of claim 1, the method further comprising:
providing a user interface to a provider of the plurality of providers, the user interface listing at least a subset of the defined plurality of medical service packages; and
receiving selection information from the provider, the selection information indicating one or more of the listed medical service packages offered by the provider.

5. The computer-implemented method of claim 1, the method further comprising:
receiving targeting criteria from a provider of the plurality of providers, the targeting criteria describing consumers to whom the provider is offering an associated medical service package;
wherein the list of one or more of the plurality of providers that offer the described one or more medical service packages is presented to the consumer based at least in part on the information associated with the consumer and the targeting criteria received from the provider.

6. The computer-implemented method of claim 1, wherein facilitating the purchase of the presented medical service package comprises facilitating a solicitation for a payment for a package by an individual other than the consumer.

7. The computer-implemented method of claim 1, the method further comprising:
receiving scheduling information from a provider of the plurality of providers, the scheduling information indicating when the provider is available to perform the presented medical service package; and
scheduling performance of the presented medical service package responsive to the scheduling information.

8. The computer-implemented method of claim 1, the method further comprising:
providing a questionnaire to the consumer, the questionnaire prompting answers from the consumer describing the consumer's personal medical history;
receiving the answers to the questionnaire from the consumer; and
recommending one or more of the plurality of medical service packages for the consumer based on the received answers;
wherein the presenting presents descriptions of the recommended one or more of the plurality of medical service packages to the consumer.

9. The computer-implemented method of claim 1, the method further comprising:
establishing one or more geographic locations of provider facilities offering the one or more of the plurality of medical service packages;
receiving a selection of one of the geographic locations of provider facilities from the consumer; and
facilitating the purchase of one of the recommended medical service packages, wherein the purchased medical service package is associated with the selected geographic location of a provider facility.

10. A non-transitory computer-readable storage medium storing instructions for providing a health care marketplace, the instructions when executed by a processor causing the processor to:
define a plurality of medical service packages offered in the health care marketplace, each medical service package comprising information about one or more medical services included in the medical service package;
establish a plurality of providers within the health care marketplace, each provider offering one or more of the plurality of medical service packages at specified prices;
receive information associated with a consumer;
present, by a computer processor, descriptions of one or more of the plurality of medical service packages and a list of one or more of the plurality of providers that offer the described one or more medical service packages to the consumer, based on the received information; and
facilitate a purchase on behalf of the consumer of a presented medical service package at a specified price from one of the providers in the list.

11. The non-transitory computer-readable storage medium of claim 9, the processor further caused to:
establish personal medical information about the consumer based at least in part on the received information associated with the consumer; and
recommend one or more of the plurality of medical service packages for the consumer based on the received personal medical information.

12. The non-transitory computer-readable storage medium of claim 10, wherein the personal medical information about the consumer comprise at least one of: demographic data about the consumer, past health condition data about the consumer, family history data about the consumer, and social history data about the consumer.

13. The non-transitory computer-readable storage medium of claim 9, the processor further caused to:
provide a user interface to a provider of the plurality of providers, the user interface listing at least a subset of the defined plurality of medical service packages; and
receive selection information from the provider, the selection information indicating one or more of the listed medical service packages offered by the provider.

14. The non-transitory computer-readable storage medium of claim 9, the processor further caused to:
receive targeting criteria from a provider of the plurality of providers, the targeting criteria describing consumers to whom the provider is offering an associated medical service package;
wherein the list of one or more of the plurality of providers that offer the described one or more medical service packages is presented to the consumer based at least in part on the information associated with the consumer and the targeting criteria received from the provider.

15. The non-transitory computer-readable storage medium of claim 9, wherein facilitating the purchase of the presented medical service package comprises facilitating a solicitation for a payment for a package by an individual other than the consumer.

16. The non-transitory computer-readable storage medium of claim 9, the processor further caused to:
receive scheduling information from a provider of the plurality of providers, the scheduling information indicating when the provider is available to perform the presented medical service package; and
schedule performance of the presented medical service package responsive to the scheduling information.

17. The non-transitory computer-readable storage medium of claim 9, the processor further caused to:
provide a questionnaire to the consumer, the questionnaire prompting answers from the consumer describing the consumer's personal medical history;
receive the answers to the questionnaire from the consumer; and
recommend one or more of the plurality of medical service packages for the consumer based on the received answers;
wherein the presenting presents descriptions of the recommended one or more of the plurality of medical service packages to the consumer.

18. A computer system comprising:
a processor; and
a memory storing instructions executable by the processor to:
define a plurality of medical service packages offered in a health care marketplace, each medical service package comprising information about one or more medical services included in the medical service package;
establish a plurality of providers within the health care marketplace, each provider offering one or more of the plurality of medical service packages at specified prices;
receive information associated with a consumer;
present, by a computer processor, descriptions of one or more of the plurality of medical service packages and a list of one or more of the plurality of providers that offer the described one or more medical service packages to the consumer, based on the received information; and
facilitate a purchase on behalf of the consumer of a presented medical service package at a specified price from one of the providers in the list.

19. The system of claim 17, the memory further executable by the processor to:
establish personal medical information about the consumer based at least in part on the received information associated with the consumer; and
recommend one or more of the plurality of medical service packages for the consumer based on the received personal medical information.

20. The system of claim 17, wherein facilitating the purchase of the presented medical service package comprises facilitating a solicitation for a payment for a package by an individual other than the consumer.
